(19) United States
(12) Patent Application Publication
(10) Pub. No.: US 2016/0017259 A1
(43) Pub. Date: Jan. 21, 2016

(54) ISONONYL ESTERS ON THE BASIS OF FATTY ACID MIXTURES CONSISTING OF VEGETABLE OILS

(71) Applicants: Benjamin WOLDT, Marl (DE); Michael GRASS, Haltern am See (DE); Michael WOELK-FAEHRMANN, (US); Charlotte SCHNEIDER, Herten (DE)

(72) Inventors: Benjamin WOLDT, Bochum (DE); Michael GRASS, Haltern am See (DE); Michael WOELK-FAEHRMANN, Marl (DE); Charlotte SCHNEIDER, Herten (DE)

(73) Assignee: EVONIK DEGUSSA GMBH, Essen (DE)

(21) Appl. No.: 14/773,594

(22) PCT Filed: Feb. 18, 2014
(86) PCT No.: PCT/EP2014/053095

§ 371 Date: Sep. 8, 2015

(30) Foreign Application Priority Data
Mar. 8, 2013 (DE) 10 2013 203 973.5

(51) Int. Cl. C11C 1/00; C08K 5/1515; C11C 1/02; C11C 3/00; C11C 1/10

(52) U.S. Cl. CPC C11C 1/002; C11C 3/006; C11C 3/003; C11C 1/10; C11C 1/02; C11C 1/005; C08K 5/1515

(57) ABSTRACT

The invention concerns an isononyl ester mixture of an epoxidized fatty acid mixture, the fatty acid mixture having been obtained from a vegetable oil, the fraction of saturated fatty acids in the isononyl ester mixture being below the fraction of saturated fatty acids in the vegetable oil from which the fatty acids have been obtained.

The invention relates to an isononyl ester mixture of an epoxidized fatty acid mixture, the fatty acid mixture having been obtained from a vegetable oil, the fraction of saturated fatty acids in the isononyl ester mixture being below the fraction of saturated fatty acids in the vegetable oil from which the fatty acids have been obtained.

The invention further relates to processes for preparing it, and to its use as plasticizer for polymers.

WO 01/98404 A2 describes plasticizers based on various fatty acid esters, in which the acid fraction originates from vegetable oils.

WO 2013/003225 A2 describes a preparation process for epoxidized fatty acid esters, referred to as “green plasticizers”.

In the journal “Visions in Plastics” from October 2012 (GIT-Verlag, vol. 3, pp. 28-29), an article “Test the Best” by D. Ortiz Martinz described significant incompatibilities exhibited by the plasticizer PLS Green 9, an epoxidized isononyl soyate.

The objectives were on the one hand to provide further esters (or ester mixtures) whose acid fraction originates from fatty acids from naturally occurring oils, and which have good plasticizer properties, and on the other hand to provide a preparation process allowing these esters (or ester mixtures) to be prepared.

The object is achieved by means of an ester mixture according to claim 1.

Isononyl ester mixture of an epoxidized fatty acid mixture, the fatty acid mixture having been obtained from a vegetable oil, the fraction of saturated fatty acids in the isononyl ester mixture being below the fraction of saturated fatty acids in the vegetable oil from which the fatty acids have been obtained, and the average number of epoxide groups per fatty acid being greater than 1.00.

In one embodiment the vegetable oil is soyabean oil.

In another embodiment the vegetable oil is rapeseed oil.

In another embodiment the vegetable oil is linseed oil.

In a further embodiment the vegetable oil is a mixture of soyabean and rapeseed oils, or of soyabean and linseed oils, or of rapeseed and linseed oils.

In one embodiment the average number of epoxide groups per fatty acid is greater than 1.20, preferably greater than 1.30, very preferably greater than 1.40.

In one embodiment the fraction of saturated fatty acids is less than 10 area %, preferably less than 8 area %, more preferably less than 4 area %.

As well as the isononyl ester mixture itself, a process for preparing it is also claimed.

Process for preparing an above-described isononyl ester mixture, comprising the following process steps:

a1) recovering a fatty acid mixture from a vegetable oil,
b1) depleting the fraction of saturated fatty acids in the fatty acid mixture,
c1) epoxidizing the fatty acid mixture,
d1) esterifying the fatty acid mixture with isononanol.

In this process, steps b1), c1) and d1) may take place in any order.

Process for preparing an above-described isononyl ester mixture, comprising the following process steps:

a2) recovering a fatty acid ester mixture from a vegetable oil,
b2) depleting the fraction of saturated fatty acid esters in the fatty acid ester mixture,
c2) epoxidizing the fatty acid ester mixture,
d2) transesterifying the fatty acid ester mixture with isononanol.

In this process, steps b2), c2) and d2) may take place in any order.

In one variant of the process, the depletion takes place by distillation of the epoxidized esters.

In one preferred process variant the fatty acid methyl ester is first of all prepared and epoxidized. The epoxidized fatty acid methyl ester is subsequently separated into a fraction rich in saturated fatty acid methyl esters and a fraction rich in epoxidized fatty acid methyl esters. This separation may be accomplished by distillation, for example.

Preference is given to a process for preparing an above-described isononyl ester mixture that comprises the following steps:
i) recovering a fatty acid ester mixture from a vegetable oil,
ii) epoxidizing the fatty acid ester mixture,
iii) depleting the fraction of saturated, epoxidized fatty acid esters in the fatty acid ester mixture, by distillation,
iv) transesterifying the epoxidized fatty acid ester mixture with isononanol.

In a further variant of the process, the depletion takes place by crystallization.

Also claimed, furthermore, is the use of the isononyl ester mixture as plasticizer in polymers.

Use of an above-described ester or ester mixture as plasticizer for a polymer selected from the following: polyvinyl chloride, polyvinylidene chloride, polylactic acid, polyurethanes, polyvinylbutyral, polyalkyl methacrylates or copolymers thereof.

Preference here is given to the use of an above-described ester or ester mixture as plasticizer for polyvinyl chloride.

The esters or ester mixtures of the invention may be used as plasticizers for the modification of polymers. These polymers are selected, for example, from the group consisting of: polyvinyl chloride (PVC), polyvinylidene chloride (PVDC), polyacrylates, especially polymethyl methacrylate (PMMA), polyalkyl methacrylate (PAMA), fluoropolymers, especially polyvinylidene fluoride (PVDF), polytetrafluoroethylene (PTFE), polyvinyl acetate (PVAc), polyvinyl alcohol (PVA), polyvinylacetals, especially polyvinylbutyral (PVB), polystyrene polymers, especially polystyrene (PS), expandable polystyrene (EPS), acrylonitrile-styrene-acrylate (ASA), styrene-acrylonitrile (SAN), acrylonitrile-butadiene-styrene (ABS), styrene-maleic anhydride copolymer (SMA), styrene-methacrylic acid copolymer, polyolefins, especially polyethylene (PE) or polypropylene (PP), thermoplastic polyolefins (TPO), polyethylene-vinyl acetate (EVA), polycarbonates, polyethylene terephthalate (PET), polybutylene terephthalate (PBT), polyoxymethylene (POM), polyamide (PA), polyethylene glycol (PEG), polyurethane (PU), thermoplastic polyurethane (TPU), polysulphides (PSu), biopolymers, especially polylactic acid (PLA), polyhydroxybutyral (PHB), polyhydroxyvaleric acid (PHV), polyesters, starch, cellulose and cellulose derivatives, especially nitrocellulose (NC), ethylcellulose (EC), cellulose acetate (CA), cellulose acetate/butyrate (CAB), rubber or silicones, and also mixtures or copolymers of the stated polymers or of their monomeric units have. The polymers of the invention preferably comprise PVC or homopolymers or copolymers based on ethylene, propylene, butadiene, vinyl acetate, glycidyl acrylate, glycidyl methacrylate, methacrylates, ethyl acrylates, butyl acrylates or methacrylates having, bonded on the oxygen atom of the ester group, alkyl radicals of branched or unbranched alcohols having one to ten carbon atoms, styrene, acrylonitrile or cyclic olefins.

The type of PVC in the polymer is preferably suspension PVC, bulk PVC, microsuspension PVC or emulsion PVC.

Based on 100 parts by mass of polymer, the polymers comprise preferably from 5 to 200, more preferably from 10 to 150, parts by mass of plasticizer.

The mixtures of PVC and the esters of the invention may also be admixed with other additives as well, such as, for example, heat stabilizers, fillers, pigments, blowing agents, biocides, UV stabilizers, etc.

The esters/ester mixtures of the invention may also be combined with other plasticizers, for example with other esters of natural fatty acids, or with oil from plant sources.

Combination may also take place, furthermore, with a plasticizer selected from the following group: adipates, benzoates, citrates, cyclohexanedicarboxylates, epoxidized fatty acid esters, epoxidized vegetable oils, epoxidized acetylated glycerides, furandicarboxylates, phosphates, phthalates, sulphonamides, sulphonates, terephthalates, trimellitates, or oligomeric or polymeric esters based on adipic, succinic or sebacic acid.

The above-described esters or ester mixtures may be used in adhesives, sealants, coating materials, varnishes, paints, plastisols, foams, synthetic leathers, floor coverings (e.g. top coat), roofing sheets, underbody protection, fabric coatings, cables or wire insulation systems, hoses, extruded articles, and also in films, particularly for the automotive interior sector, and also in wallpapers or inks.

### Preparation of the Compounds

### EXAMPLE 1

### Depletion and Enrichment of Saturated Fatty Acid Methyl Esters by Distillation from Epoxidized Methyl Soyate

By virtue of lower boiling points, the saturated fatty acid methyl esters can be separated distillatively from the epoxidized fatty acid methyl esters. For this purpose a KDL 5 short-path evaporator (UIC GmbH) was used. Evaporator, distillate stream and reflux stream were heatable separately via thermostats. 5000 g of an epoxidized methyl soyate (Reflex 100 from PolyOne) were distilled under the following conditions:

| | |
|---|---|
| Pressure: | <10⁻³ mbar |
| Evaporator temperature: | 120° C. |
| Distillate temperature: | 40° C. |
| Residue temperature: | 40° C. |
| Wiper speed: | 313 rpm |
| Inward conveying pump speed: | 400 rpm |

Under the conditions described, 74 mass % of the product were obtained as residue, and 26 mass % as distillate. As confirmed by the analytical data from Table 1, the saturated fatty acids were enriched in the distillate, to a fraction of 44.6%, and depleted in the residue, to a fraction of 2.6%. Residue and distillate were used independently of one another for further chemical reactions (examples 2, 3).

### EXAMPLE 2

### Preparation of Epoxidized Isononyl Soyate from Depleted Epoxidized Methyl Soyate (Residue from Example 1)

### Batch:

888 g of epoxidized methyl soyate (example 1, residue)
540 g of isononanol (from Evonik)
2.22 g of tetraisononyl titanate (TINT) (obtainable by transesterifying tetrabutyl titanate from Johnson Matthey with isononanol from Evonik; nonyl titanate purity 95%)

### Transesterification:

All of the reactants and the catalyst were charged to a transesterification apparatus with a 4 l reaction flask, stirrer, immersion tube, thermometer, distillation head, 20 cm Raschig ring column, vacuum divider and collecting flask. The apparatus was flushed via the immersion tube with 6 l N₂/hour for one hour.

The reactants were heated slowly to 180° C. with stirring. At temperatures above 160° C., methanol was produced, and was removed from the reaction continuously via the distillation head. When 180° C. was reached, vacuum was applied and the pressure was reduced continuously over the course of the reaction. After 8 hours a further 100 g of isononanol and 1.11 g of TINT were added. The reaction time was 16.5 hours. The vacuum at the end of the reaction was 133 mbar.

The conversion was monitored via GC analysis. The batch was shut off when the fraction of epoxidized biodiesel was <3 area %. The 1^{st} sample was taken after an hour, and then the conversion was monitored by GC analyses at regular intervals through to the end of reaction.

The reaction effluent from the transesterification was transferred to a 4 l reaction flask and admixed with 2% of activated carbon, based on the mass of reaction effluent. The flask was attached to a Claisen bridge with vacuum divider. In addition, an immersion tube with nitrogen connection was inserted into the flask. In addition a thermometer was attached. The batch was flushed with nitrogen while stirring. Under maximum vacuum (<1 mbar), heating took place slowly and the temperature was raised slowly, in accordance with the distillation yield, up to 180° C. 248 g of low boilers were separated off and then discarded. The reaction material was cooled to <90° C. and then filtered. For this purpose, the ester was filtered through a BUchner funnel with filter paper and precompacted filter cake of filter aid (D14 perlite) using reduced pressure, into a suction bottle.

### EXAMPLE 3

### Preparation of Epoxidized Isononyl Soyate from Enriched Epoxidized Methyl Soyate (Distillate from Example 1)

### Batch:

888 g of epoxidized methyl soyate (example 1, distillate)
540 g of isononanol (from Evonik)
2.22 g of tetraisononyl titanate (TINT) (obtainable by transesterifying tetrabutyl titanate from Johnson Matthey with isononanol from Evonik; nonyl titanate purity 95%)

### Transesterification:

All of the reactants and the catalyst were charged to a transesterification apparatus with a 4 l reaction flask, stirrer, immersion tube, thermometer, distillation head, 20 cm Raschig ring column, vacuum divider and collecting flask. The apparatus was flushed via the immersion tube with 6 l N₂/hour for one hour.

The reactants were heated slowly to 180° C. with stirring. At temperatures above 152° C., methanol was produced, and was removed from the reaction continuously via the distillation head. When 180° C. was reached, vacuum was applied and the pressure was reduced continuously over the course of the reaction. The reaction time was 4 hours. The vacuum at the end of the reaction was 46 mbar.

The conversion was monitored via GC analysis. The batch was shut off when the fraction of epoxidized biodiesel was <0.3 area %. The 1^{st} sample was taken after an hour, and then the conversion was monitored by GC analyses at regular intervals through to the end of reaction.

The reaction effluent from the transesterification was transferred to a 4 l reaction flask and admixed with 2% of activated carbon, based on the mass of reaction effluent. The flask was attached to a Claisen bridge with vacuum divider. In addition, an immersion tube with nitrogen connection was inserted into the flask. In addition a thermometer was attached. The batch was flushed with nitrogen while stirring. Under maximum vacuum (<1 mbar), heating took place slowly and the temperature was raised slowly, in accordance with the distillation yield, up to 180° C. 107 g of low boilers were separated off and then discarded. The reaction material was cooled to <90° C. and then filtered. For this purpose, the ester was filtered through a Buchner funnel with filter paper and precompacted filter cake of filter aid (D14 perlite) using reduced pressure, into a suction bottle.

### Comparative Experiments for Plastisol Use:

### 1. Physicochemical Data of the Pure Plasticizer

### 1.1 Volatility

The volatility of plasticizers is a central property for many polymer applications. High volatilities lead to environmental exposure and, as a result of reduced plasticizer fractions in the polymer, to impaired mechanical properties. For these reasons, volatile plasticizers are often only admixed in small fractions to other plasticizer systems, or are not used at all. The volatility is particularly significant, for example, in interior applications (wallpapers, cars) or, owing to directives and standards, in the case of cables or food packaging. The volatility of the pure plasticizers was determined by means of the Mettler Toledo HB 43-S halogen dryer. Prior to measurement, a clean, empty aluminium boat was placed in the weighing pan. The aluminium boat was then tared with a mat, and about five grams of plasticizer were pipetted onto the mat and weighed accurately.

Measurement commenced with the closing of the heating module, and the sample was heated at maximum rate (preset) from room temperature to 200° C., with the corresponding loss of mass through vaporization being determined automatically by weighing every 30 seconds. After 10 minutes, the measurement was ended automatically by the instrument.

A duplicate determination was carried out on each sample.

### 1.2 Viscosity and Density

The Stabinger SVM 3000 viscometer is a combination instrument which can be used to determine density and viscosity. For this purpose, the instrument has two measuring cells in series.

To determine the viscosity, a rotary viscometer with cylinder geometry is installed, and, to determine the density, a density measuring cell operating on the oscillating U-tube principle. Accordingly, a single injection of the sample provides both measurement values. Sample measurement takes place at 20° C. The measuring cells are conditioned using a Peltier element (reproducibility 0.02° C.).

The samples are measured using the preset measurement mode “M0-ASTM (PRECISE)”, measurement with very high accuracy and repetitions, for tests in accordance with the standard ASTM D7042. For each measurement, about 0.5 ml of sample is metered in (in order to rule out air inclusions or impurities).

For the internal repetitions, a valid result is displayed only when the deviation in the values is not greater than +/−0.1% of the viscosity measurement and +/−0.0002 g/cm3 for the density.

In addition to the internal repetitions, a duplicate determination is carried out on each sample. After each determination, the instrument is cleaned with acetone and dried with air (installed pump).

### 1.3 Description of Method for Determining the Fraction of Double Bonds, Epoxides and Alcohols Via NMR Spectroscopy

The fraction of double bonds, epoxides and alcohols is determined by ¹H NMR spectroscopy. For the recording of the spectra, for example, 50 mg of substance are dissolved in 0.6 ml of CDCl₃ (containing 1% by mass of TMS) and the solution is introduced into a 5 mm diameter NMR tube.

The NMR spectroscopy analyses can be carried out in principle with any commercial NMR instrument. For the present NMR spectroscopy analyses, a Bruker Avance 500 instrument was used. The spectra were recorded at a temperature of 303 K with a delay of d1=5 seconds, 32 scans, a pulse length of about 9.5 μs, and a sweep width of 10 000 Hz, using a 5 mm BBO (broad band observer) sample head. The resonance signals are plotted against the chemical shift from tetramethylsilane (TMS=0 ppm) as internal standard. Comparable results are obtained with other commercial NMR instruments, with the same operating parameters.

To determine the fractions of the individual structural elements it is necessary first to identify the associated signals in the NMR spectrum. Listed below are signals used with their position in the spectrum and their assignment to corresponding structural elements:
the signals in the 4.8 to 6.4 ppm region were assigned to the ¹H nuclei of the double bonds.
the signals in the 4.0 to 3.25 ppm region were assigned to the ¹H nuclei of the alcohols.
the signals in the 3.25 to 2.85 ppm region were assigned to the ¹H nuclei of the epoxides.

Quantification of the fractions requires reference signals of known size. Methylene groups of the fatty acid radical or of the alcohol radical of the fatty acid esters were used. In the case of the isononyl and isodecyl esters, signals of the alcohol are partially superimposed on the signal of the methylene group at 2.3 ppm, and therefore the methylene group of the alcohol at around 4 ppm was employed. The signals used were as follows:
the signals of the methylene group adjacent to the carboxyl group of the fatty acid, resonating in the spectrum as a narrow signal multiplet around 2.3 ppm.
the signals of the methylene group adjacent to the oxygen of the esterified alcohol (isononyl alcohol or isodecyl alcohol), corresponding to the structural element —CH₂—O—, which resonate in the spectrum in the 3.9 to 4.2 ppm region.

Quantification takes place by determination of the area under the respective resonance signals, i.e., the area enclosed from the baseline by the signal. Commercial NMR instruments possess devices for integrating the signal area. In the present NMR spectroscopy analysis, the integration was carried out by means of the TOPSPIN software, Version 3.1.

In order to calculate the fraction of the double bonds, the integral value x of the double bond signals in the 4.8 to 6.4 ppm region is divided by the integral value of the reference methylene group r.

To calculate the fraction of the epoxides, the integral value y of the epoxide signals in the 2.85 to 3.25 ppm region is divided by the integral value of the reference methylene group r.

To calculate the fraction of the alcohols, the integral value z of the alcohol signals in the 3.9 to 3.25 ppm region is divided by half the integral value of the reference methylene group r/2.

This gives the relative fractions of the double bond, epoxide and alcohol structural elements for each fatty acid radical.

### 1.4 Fraction of Saturated Fatty Acids

For the gas chromatography analyses, 2 methods were used, and the results from both measurements were combined.

GC analysis by method 1 took place with the following parameters:

Capillary column: 30 m DB-WAX; 0.32 mm ID; 0.5 μm film
Carrier gas: helium
Total flow rate: about 106 mL/min
Split: about 100 ml/min
Oven temperature: 80° C.-10° C./min-220° C. (40 min)

### Injector: 250° C.

### Detector (FID): 250° C.

Injection volume: 1.0 μl

The components in the chromatogram of the sample were identified using a comparative solution of the relevant fatty acid methyl esters. In this case the methyl esters in question are those of myristic, palmitic and stearic acid. This was followed by standardization of the signals in the chromatogram with run times of between 8 and 20 min of the sample to 100 area %. Method 1 permits separation and quantification of the saturated and unsaturated fatty acid methyl esters among one another. For determining the fraction of the saturated fatty acids in the epoxidized fatty acids, the sample (prepared as described above) is diluted 1:10 with heptane and analysed by method 2.

GC analysis by method 2 took place with the following parameters:

Capillary column: 30 m DB-5HT; 0.32 mm ID; 0.1 μm film
Carrier gas: helium
Column flow rate: 2.6 ml/min
Oven temperature: 80° C.-20° C./min-400° C. (30 min)
Injector: cool on column, 80° C.-140° C./min-400° C.

### Detector (FID): 400° C.

Injection volume: 1.0 μl

The procedure used for evaluating the area percent distribution of the saturated fatty acid methyl esters was as follows: first of all, the retention time range of the saturated and unsaturated fatty acid methyl esters was identified using a comparative solution of relevant fatty acid methyl esters. All of the signals of the fatty acid methyl esters (saturated, unsaturated and epoxidized fatty acid methyl esters) as fatty acids were standardized to 100 area %. The fractions of the individual fatty acid methyl esters in area % could then be calculated as follows:

Fraction of the fatty acid methyl esters (saturated and unsaturated by method II in area %) multiplied by the fraction of the respective fatty acid methyl ester (saturated and unsaturated by method I in area %/100%). The fraction of the saturated FA is then given by summing of the fractions of myristic, palmitic and stearic fatty acid methyl ester.

### EXAMPLE

Method 1 supplies the area percentages of the saturated and unsaturated fatty acid methyl esters (epoxidized fatty acid methyl esters are not included):

| | |
|---|---|
| Methyl myristate | 00.00 area % |
| Methyl palmitate | 17.11 area % |
| Methyl stearate | 46.94 area % |
| Remainder | 35.95 area % |
| Total | 100.00 area % |

The sum total of the saturated fatty acids according to method 1 is therefore 64.05 area %.

Method 2 yields the area percentages of the epoxidized fatty acid methyl esters

| | |
|---|---|
| Un/saturated fatty acid methyl esters | 4.85 area % |
| Epoxidized fatty acid methyl esters | 95.15 area % |

The fraction of saturated fatty acid methyl esters in the plasticizer is then calculated as follows: 0.6405×0.0485×100 area %=3.11 area %

The results are shown in Table 1. The plasticizer number (PZ No.) here correlates with the formulation number from Table 2.

TABLE 1

| | | | | | | | Fraction |
|---|---|---|---|---|---|---|---|
| | Loss of mass | | | | | | of sat. |
| PZ | 200° C./10 min | Viscosity | Density | EN/FA | DB/FA | OHN/FA | FA |
| No. | [%] | [mPas] | [mg/cm³] | [eq.] | [eq.] | [eq.] | [area %] |
| 1 | 4.4 | 76 | 0.9741 | — | — | — | — |
| 2 | 4.0 | 50 | 0.9243 | 1.21 | 0.05 | 0.29 | 17.7 |
| 3* | 2.3 | 61 | 0.9364 | 1.62 | 0.01 | 0.22 | 2.6 |
| 4 | 5.5 | 26 | 0.8908 | 0.75 | 0.01 | 0.04 | 44.6 |

*inventive ester mixture
EN/FA: average number of epoxide groups per fatty acid
DB/FA: average number of double bonds per fatty acid
OHN/FA: average number of alcohol groups per fatty acid

For the inventive ester (3), the mass losses of the pure plasticizer are well below the mass loss for the industry standard DINP (1) and the comparative substance PLS Green 9, a commercially available epoxidized fatty acid isononyl ester based on soya fatty acids (PZ No. 2). High volatilities lead to environmental exposure and, as a result of reduced plasticizer fractions in the polymer, to impaired mechanical properties.

### 2. Production of the Plastisol

A PVC plastisol was produced, of the type which is used, for example, to fabricate top coat films for floor coverings. The data in the plastisol formulations are in each case in weight fractions. The PVC used was Vestolit B 7021-Ultra. The comparative substances used were diisononyl phthalate (DINP, VESTINOL 9 from Evonik Industries) and epoxidized isononyl soyate (PLS Green 9 from Petrom). The formulations of the polymer compositions are listed in Table 2.

TABLE 2

| Formulation: | 1 | 2 | 3* | 4 |
|---|---|---|---|---|
| B 7021-Ultra | 100 | 100 | 100 | 100 |
| DINP | 50 | | | |
| Epox. isononyl fatty acid ester (ex | | 50 | | |
| soyabean oil; PLS Green 9) | | | | |
| Epox. isononyl fatty acid ester (ex | | | 50 | |
| soyabean oil; sat. FA depleted) | | | | |
| Example 2 | | | | |
| Epox. isononyl fatty acid ester (ex | | | | 50 |
| soyabean oil; sat. FA enriched) | | | | |
| Example 3 | | | | |
| Drapex 39 | 3 | 3 | 3 | 3 |
| Mark CZ 149 | 2 | 2 | 2 | 2 |

*Polymer composition comprising an inventive ester mixture

In addition to the 50 parts by weight of plasticizer, each formulation also contains 3 parts by weight of an epoxidized soyabean oil as co-stabilizer (Drapex 39, from Galata), and also 2 parts by weight of a Ca/Zn-based heat stabilizer (Mark CZ 149, from Galata).

The plasticizers were conditioned to 25° C. prior to addition. First the liquid constituents and then those in powder form were weighed out into a PE beaker. The mixture was stirred by hand with a paste spatula until there was no longer any unwetted powder. The mixing beaker was then clamped into the clamping apparatus of a dissolver-stirrer. Before the stirrer was immersed into the mixture, the speed was adjusted to 1800 revolutions per minute. After the stirrer was switched on, stirring took place until the temperature on the digital display of the thermosensor reached 30.0° C. This ensured that homogenization of the plastisol was achieved with a defined energy input. The plastisol was thereafter immediately conditioned at 25.0° C.

### 3. Gelling Behaviour

The gelling behaviour of the pastes was studied in a Physica MCR 101 in oscillation mode using a plate/plate measurement system (PP25), which was operated with shear-stress control. An additional temperature-regulating hood was attached to the equipment in order to homogenize heat distribution and achieve a uniform sample temperature.

The settings for the parameters were as follows:

Mode: temperature gradient
starting temperature: 25° C.
final temperature: 180° C.
heating/cooling rate: 5° C./min
oscillation frequency: 4-0.1 Hz ramp logarithmic
angular frequency omega: 10 1/s
number of measurement points: 63
measurement point duration: 0.5 min
automatic gap adjustment F: 0 N
constant measurement point duration
gap width 0.5 mm

### Measurement Procedure:

A spatula was used to apply a drop of the plastics to be measured, free from air bubbles, to the lower plate of the measurement system. Care was taken here to ensure that some paste could exude uniformly out of the measurement system (not more than about 6 mm overall) after the measurement system had been closed. The temperature-regulating hood was then positioned over the specimen, and the measurement was started. The so-called complex viscosity of the paste was determined as a function of the temperature. Since a certain temperature is attained within a time span (determined by the heating rate of 5° C./min.), information is obtained about the gelling rate of the measured system, as well as about its gelling temperature. The onset of the gelling process was discernible in a sudden marked rise in the complex viscosity. The earlier the onset of this viscosity rise, the better the gellability of the system.

The measurement curves obtained were used to determine the cross-over temperature. This method computes the point of intersection for the two y-variables chosen. It is used to find the end of the linear viscoelastic region in an amplitude sweep (y: G′, G″; x: gamma), in order to find the crossing frequency in a frequency sweep (y: G′, G″; x: frequency) or in order to ascertain the gel time or cure temperature (y: G′, G″; x: time or temperature). The cross-over temperature documented here corresponds to the temperature of the first intersection of G′ and G″.

The results are shown in Table 3. The paste number here correlates with the formulation number from Table 2.

TABLE 3

| | Paste No. | | | |
|---|---|---|---|---|
| | 1 | 2 | 3* | 4 |
| Cross-over temperature ° C. | 75.9 | 74.2 | 71.2 | 83.1 |

*Paste comprising an inventive ester mixture

The paste (3) with the inventive ester mixture shows the lowest cross-over temperature. This is synonymous with accelerated gelling. Paste (4), in contrast, with an increased fraction of saturated fatty acids, shows a significantly increased cross-over temperature as compared with paste (2).

As a further measure of the gelling, a distinct increase in the complex viscosity is observed. As a value for comparison, therefore, the temperature on attainment of a paste viscosity of 1000 Pas is used. The results are set out in Table 4. The paste number here correlates with the formulation number from Table 2.

TABLE 4

| | Paste No. | | | |
|---|---|---|---|---|
| | 1 | 2 | 3* | 4 |
| Temperature at 1000 Pas | 86 | 111 | 84 | 147 |

*Paste comprising an inventive ester mixture

Paste (3), with the inventive ester mixture, attains the required viscosity at a lower temperature than does DINP (1). This likewise points to an improved gelling behaviour. The pastes with an increased fraction of saturated fatty acids (4), but also paste (2), prepared from a vegetable oil without depletion of the saturated fatty acids, exhibit a comparatively poor gelling.

For further investigations on plasticized PVC specimens, fully gelled 1 mm polymer films were produced from the corresponding plastisols (gelling conditions in the Mathis oven: 200° C./2 min).

### 4. Thermal Stabilities

The thermal stability measurements were carried out on a Thermotester (model LTE-TS from Mathis AG). The sample frame for the thermal stability measurement is fitted with 14 aluminium rails. The aluminium rails serve as sample holders, in which samples up to a maximum width of 2 cm are placed. The sample length is 40 cm.

The edges of the foils under investigation were removed using a guillotine, and the foils were cut to give rectangles (dimensions: 20 cm×30 cm). Then two strips (20*2 cm) were cut off.

The strips were fastened alongside one another into the aluminium rails of the frame for the thermal stability measurement. After establishment of temperature, the frame was slotted into the guide of the Thermotester, and measurement was started. The parameters set on the Mathis Thermotester were as follows:

### Temperature: 200° C.

Interval advance: 28 mm
Interval time: 1 min
Ventilator rotation rate: 1800 rpm Using a Byk colorimeter (Spectro Guide 45/0 from Byk Gardner), determinations were made of the L*a*b*, including a yellowness index Y in accordance with the D1925 index. To achieve optimum results, the illuminant set was C/2°, and a sample observer was used. The thermal stability strips were then measured on each advance (28 mm). Since the thermal stability strips consist of two 20 cm strips, the measurement was not ascertained at the point of cutting. The measurement values were determined directly on the sample card, behind a white tile. The first measurement value following exceedance of the yellowness index maximum was identified as blackening.

The results are set out in Table 5. The specimen number here correlates with the formulation number from Table 2.

TABLE 5

| | Specimen number | | | |
|---|---|---|---|---|
| | 1 | 2 | 3* | 4 |
| Time to blackening (min) | 11 | >14 | >14 | — |

The specimens (2) and (3) showed no blackening in the Thermotester within the time interval under consideration. The thermal stability is significantly increased as compared with the industry standard DINP (1). This significant increase is a result of the capture by the epoxide function of HCl that has been formed. In the case of specimen (4), there was severe exudation of the plasticizer owing to low compatibility with the PVC. The cause of this is the high fraction of saturated fatty acids. With this sample no proper measurement was possible.

### 5. Plasticizing Effect

The Shore hardness is a measure of the flexibility of a specimen. The greater the extent to which a standardized needle can penetrate the specimen within a defined measurement time, the lower the value of the measurement. The plasticizer with the greatest efficiency produces the lowest Shore hardness value for the same quantity of plasticizer. Since, in the art, formulations/recipes are frequently set to or optimized for a defined Shore hardness, therefore, it is possible with very efficient plasticizers to make a saving of a defined fraction in the formulation, which means a reduction in costs for the processor.

For determination of the Shore hardnesses, the pastes produced as described above were poured into circular brass casting moulds with a diameter of 42 mm (initial mass: 20.0 g). The pastes in the moulds were then gelled in a forced air drying cabinet at 200° C. for 30 minutes, removed after cooling, and stored in a conditioning cabinet (25° C.) for at least 24 hours prior to measurement. The thickness of the discs was about 12 mm.

The hardness measurements were carried out in accordance with DIN 53 505 using a Zwick-Roell Shore A instrument, with the measurement value being read off after 3 seconds in each case. For each specimen, measurements were carried out at three different locations, and an average was formed.

The results are set out in Table 6. The specimen number here correlates with the formulation number from Table 2.

TABLE 6

| | Specimen number | | | |
|---|---|---|---|---|
| | 1 | 2 | 3* | 4 |
| Shore A | 82 | 82 | 78 | 97 |

In comparison to the industry standard DINP (specimen 1), only the inventive ester mixture specimen (3) exhibits a lower Shore hardness. The plasticizers of the invention can be used to produce PVC blends which possess better efficiency than when the corresponding DINP is used. As a result, a plasticizer saving can be made, leading to reduced formulation costs.

### 6. Water Resistance

The ageing resistance under various ambient conditions is a further significant quality criterion for PVC plasticizers. In particular, the behaviour with respect to water (water uptake and leeching behaviour of formulation ingredients) and to elevated temperatures (evaporation of formulation ingredients plus thermal ageing) offers an insight into the ageing resistance.

Water resistance was determined using fully gelled 1 mm polymer films produced from the corresponding plastisols (gelling conditions in the Mathis oven: 200° C./2 min). Test specimens used were roundels 3 cm in diameter, cut from the films. Prior to water storage, the test specimens were stored in a desiccators provided with drying agent (KC drying beads from BASF SE) at 25° C. for 24 hours. The initial weight (initial mass) was determined with an analytical balance to an accuracy of 0.1 mg. The test specimens were then stored in a shaker bath (of type WNB 22 with CDP Peltier cooling system, from Memmert GmbH), filled with fully demineralised (DI) water, at a temperature of 30° C. for 7 days with sample holders under the water surface, with continuous agitation. Following storage, the roundels were removed from the water bath, dried off and weighed (=weight after 7 days). After the reweighing, the test specimens were again stored in a desiccator provided with drying agent (KC drying beads) at 25° C. for 24 hours, and then weighed once again (final mass=weight after drying). The difference relative to the initial mass prior to water storage was used to calculate the percentage mass loss due to water storage (corresponding to loss by leeching).

The results are shown in Table 7. The test specimen number here correlates with the formulation number from Table 2.

TABLE 7

| | Specimen No. | | | |
|---|---|---|---|---|
| | 1 | 2 | 3* | 4 |
| Mass loss after drying [%] | 0.07 | 0.20 | 0.10 | — |

The mass losses of all the test specimens are very good, with values of <0.5%. Significantly increased mass losses greatly restrict the scope for use of the plasticizers. In the case of specimen (4) there was severe exudation of the plasticizer because of low compatibility with the PVC. The cause of this is the high fraction of saturated fatty acids. No proper measurement was possible with this sample.

The experiments described above have shown that the esters of the invention display very good plasticizer properties. It was found that the plasticizer properties of the ester can be modified, and therefore tailored, via the fraction of saturated fatty acids. The result of depletion of saturated fatty acids in the ester mixture is an increase in the fraction of unsaturated fatty acids (before epoxidization) and therefore in the fraction of epoxide groups per fatty acid (after epoxidization).

It is therefore possible to optimize the ester specifically to that quality of the plasticizer that is considered critical in the planned use of the plasticizer.

1. An isononyl ester mixture comprising an epoxidized fatty acid mixture, the fatty acid mixture having been obtained from a vegetable oil,
wherein
a fraction of saturated fatty acids in the isononyl ester mixture is below a fraction of saturated fatty acids in the vegetable oil from which the fatty acids have been obtained, and
an average number of epoxide groups per fatty acid is greater than 1.00.

2. The isononyl ester according to claim 1, wherein the vegetable oil is soyabean oil.

3. The isononyl ester mixture according to claim 1, wherein the average number of epoxide groups per fatty acid is greater than 1.20.

4. The isononyl ester mixture according to claim 1, wherein the fraction of saturated fatty acids is less than 10 area %.

5. A process for preparing an isononyl ester mixture according to claim 1, comprising:
a1) recovering a fatty acid mixture from a vegetable oil,
b1) depleting the fraction of saturated fatty acids in the fatty acid mixture,
c1) epoxidizing the fatty acid mixture, and
d1) esterifying the fatty acid mixture with isononanol.

6. A process for preparing an isononyl ester mixture according to claim 1, comprising:
a2) recovering a fatty acid ester mixture from a vegetable oil,
b2) depleting the fraction of saturated fatty acid esters in the fatty acid ester mixture,
c2) epoxidizing the fatty acid ester mixture, and
d2) transesterifying the fatty acid ester mixture with isononanol.

7. The process according to claim 5, wherein the depletion takes place by distillation of the epoxidized esters.

8. The isononyl ester mixture according to claim 1, wherein the isononyl ester mixture is suitable as plasticizer for polymers.
